(19) United States
(12) Patent Application Publication
(10) Pub. No.: US 2010/0059321 A1
(43) Pub. Date: Mar. 11, 2010

(54) POSITION SENSITIVE DAMPER

(76) Inventor: Denis Boivin, Beaumont (CA)

Correspondence Address: SUTHERLAND ASBILL & BRENNAN LLP, 999 PEACHTREE STREET, N.E., ATLANTA, GA, 30309, US

(21) Appl. No.: 12/518,414

(22) PCT Filed: Jan. 16, 2008
(86) PCT No.: PCT/CA08/00077

§ 371 Date: Jun. 9, 2009

Related U.S. Application Data
(60) Provisional application No. 60/885,061, filed on Jan. 16, 2007.

(51) Int. Cl. F16F 9/50

(52) U.S. Cl. 188/284

(57) ABSTRACT

The damper generally has a cylinder with a damping fluid, and a piston having a connecting rod slidably carrying a first damping piston head and an obstructing portion in the cylinder. Further, a second damping piston head is slidably mounted in the cylinder, independently from the piston, and biased to a neutral position. The second damping piston head has a damping flow path and a bypass flow path which is normally kept in an open state. When an abnormally strong shock occurs, the displacement of the first damping piston head exceeds its normal displacement span and the obstructing portion is placed into obstruction with the bypass flow path, thereby forcing the damping fluid through the damping flow path of the second damping piston head.

### FIELD

The improvements generally relate to the field of dampers, and more particularly to a damper which offers position-sensitive damping.

### BACKGROUND

Dampers are used in a plurality of mechanical devices, and are typically comprised of a damping piston head slidably mounted in a cylinder filled with a damping fluid such as oil or air. In suspensions, dampers are typically combined with one or more springs which slidably bias the piston head to a neutral position. When a shock occurs, the piston head offers a damping resistance by travelling against the damping fluid in a compression orientation. The spring then displaces the piston head in a rebound orientation, back into the neutral position.

Typically, the damping resistance varies as a function of the speed of displacement of the damping piston head, and a damper can thus be characterized by its displacement-speed-dependent damping curve. Some dampers offer damping in both the compression and the rebound orientation. Furthermore, some dampers provide different damping curves in the compression and the rebound orientations.

An insufficiency of many known dampers is that the damping curve is independent of the position of the damping piston head. In such dampers, the damping is adjusted to damp shocks of average force. However, such dampers are susceptible to a phenomenon known as “bottoming” where the damping piston head can come into contact with the end of the cylinder when an excessive or abnormal shock occurs. Bottoming is generally recognized as being undesirable.

Although known dampers were satisfactory to a certain degree, there remained room for improvement.

### SUMMARY

In accordance with one aspect, the damper has a cylinder with a damping fluid, and a piston having a connecting rod slidably carrying a first damping piston head and an obstructing portion in the cylinder. A second damping piston head is slidably mounted in the cylinder, independently from the piston, and biased to a neutral position. The second damping piston head has a damping flow path and a bypass flow path which is normally kept in an open state. When an excessive or abnormal shock occurs, the displacement of the first damping piston head exceeds its normal displacement span and the obstructing portion is placed into obstruction with the bypass flow path, thereby forcing the damping fluid through the damping flow path of the second damping piston head.

In accordance with one aspect, there is provided a damper comprising a cylinder with a damping fluid, a piston having a connecting rod slidably carrying a first damping piston head in the cylinder and an obstructing portion, and a second damping piston head slidably mounted in the cylinder independently from the piston and biased to a neutral position, the second damping piston head having a damping flow path and a normally open bypass flow path, the normally open bypass flow path being obstructable by the obstructing portion to force the damping fluid through the damping flow path.

In accordance with another aspect, there is provided a method of damping with a damper having a first damping piston head and an obstructing portion collectively normally slid in a first portion of a cylinder having damping fluid and a second piston head having a bypass flow path and a damping flow path, the second piston head being slidable in a second portion of the cylinder, independently of the first piston head, and biased to a neutral position, the method comprising : sliding the first damping piston head and the obstructing portion into the second portion of the cylinder, thereby obstructing the bypass flow path of the second piston head with the obstructing portion and forcing damping fluid through the damping flow path.

In accordance with another aspect, there is provided a damper comprising a first damping piston head, and a second piston head having a compression damping flow path and a normally open bypass flow path, both the first piston head and the second piston head being slidably mounted in an elongated cylinder having damping fluid therein, the cylinder having a first portion and a second portion along its length, the damper also having a blocking portion configured and adapted for blocking the bypass flow path when the first piston head slides into the second portion of the cylinder, thereby forcing the damping fluid into the compression damping flow path of the second piston head; the damper being CHARACTERIZED IN THAT the second piston head is slidable in the cylinder independently from the first piston head and is slidably biased to an equilibrium position along the cylinder, and in that the blocking portion is associated with the first piston head.

Providing the second piston head separately from the first piston head allows obstructing the bypass flow path from the first piston head side of the second piston head. This can ease releasing the second piston head from the first piston head when the movement of the first piston head changes orientation.

In accordance with another aspect, there is taught herein a way to make the damping of the second piston head externally adjustable.

Many further features and combinations thereof concerning the present improvements will appear to those skilled in the art following a reading of the instant disclosure.

### DESCRIPTION OF THE FIGURES

In the figures,

FIG. 1 is a schematic cross-sectional view of an example of a damper;

FIG. 2 is an enlarged view of a portion of FIG. 1;

FIG. 3 is an enlarged view showing an alternate example of a damper;

FIG. 4 is an enlarged view showing another alternate example of a damper;

FIG. 5 is a side and bottom view showing another alternate example of a damper;

FIG. 6 is a side and bottom view showing another alternate example of a damper;

FIG. 7 is an enlarged view showing another alternate example of a damper;

FIG. 8 is a cross-sectional view showing an alternate of a second piston head;

FIG. 9 is an schematic cross-sectional view showing an alternate example of a damper; and

FIG. 10 is an schematic cross-sectional view showing an alternate example of a damper.

### DETAILED DESCRIPTION

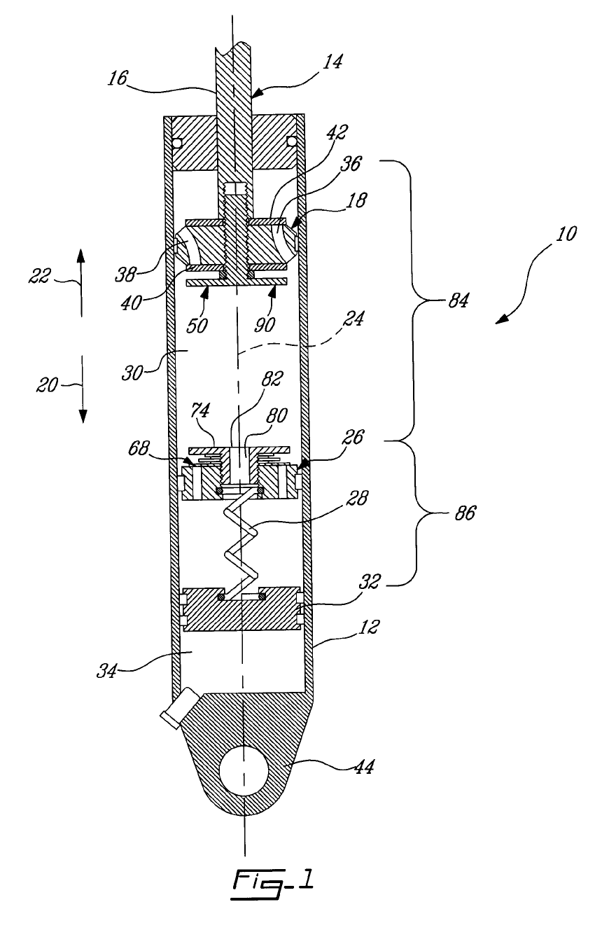

FIG. 1 shows an example of a damper 10. The damper 10 has a cylinder 12, and a piston 14 having a connecting rod 16 slidably carrying a first damping piston head 18 within the cylinder 12. The piston 14 is capable of displacement in both a compression orientation 20 and an opposite rebound orientation 22 along a stroke axis 24. The damper 10 also has a second damping piston head 26 slidably mounted in the cylinder 12 independently from the piston 14. The second piston head 26 is biased to the shown neutral position by a spring 28. The space around the first and second piston heads 18 and 26 is filled with a hydraulic damping fluid 30. The damper 10 also has a floating piston head 32 to which the spring 28 is attached. The floating piston head 32 separates the damping fluid 30 from a compressible gas 34. Upon displacement of the piston 14 in the compression orientation 20, the floating piston 32 is displaced in the compression orientation 20, compressing the gas 34, to compensate for the volume occupied by the portion of the connecting rod 16 which enters the cylinder 12.

The first piston head 18 has two independent damping fluid flow paths : a compression flow path 36 and a rebound flow path 38, which are schematically shown. As it is known in the art, a rebound washer stack 40 can be provided to block the rebound flow path 38 when the piston 14 is displaced in the compression orientation 20, and a compression washer stack 42 can be provided to block the compression flow path 36 when the piston 14 is displaced in the rebound orientation 22. The washer stacks 40, 42 can include one or more washers and their particular configurations contributes to determine the damping curves of the piston 14 in the rebound orientation 22 and compression orientation 20.

In use, the free end (not shown) of the connecting rod 16 is connected to a first relatively movable part of a mechanical device (not shown), and the opposite attachment end 44 of the cylinder is connected to a second relatively movable part of the mechanical device. When a compressive force occurs between the relatively movable parts, the first piston head 18 is displaced in the compression orientation 20. The rebound washer stack 40 acts as a check valve and forces the damping fluid 30 through the compression flow path 36 and through the compression washer stack 42, which generates a resistance to compression (i.e. a compressive damping force). After the compressive force, a spring (not shown) returns the piston 14 to its initial position by displacement thereof in the rebound orientation 22. The compression washer stack 42 acts as a check valve and forces the damping fluid 30 through the rebound flow path 38 and through the rebound washer stack 40, which generates a resistance to rebound (i.e. a rebound damping force). The response curves of the piston 14 in compression and rebound can independently be adjusted by the choice of washer stacks used.

In practice, the compression flow path 36 and the rebound flow path 38 are each comprised of a plurality of channels tangentially interspaced around the piston head 18. This example of a damping piston head 10 is being given for illustrative purposes only, and many possible alternate configurations can be used instead. Typically, damping piston heads used will at least offer a damping response curve in compression, but may allow free passage of the damping fluid during rebound.

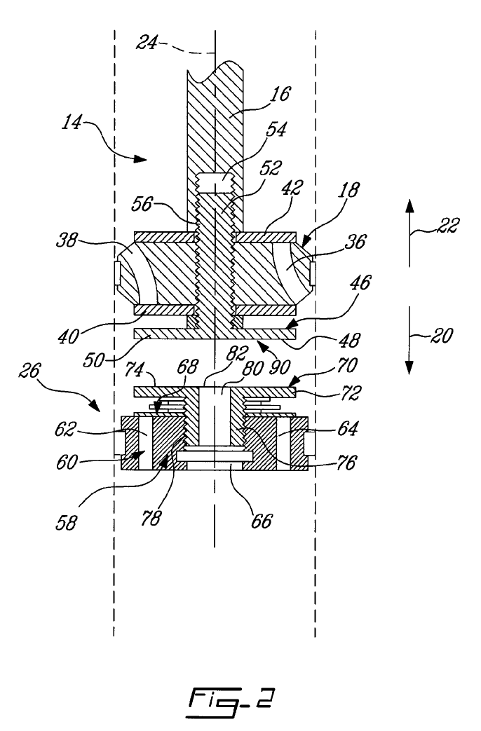

As can be seen more clearly in FIG. 2, the piston 14 also includes an obstructer 46 which in this case has a head 48 with a flat obstructing portion 50 and a threaded shaft 52, opposite the head 48, extending through the first piston head 18 and secured within a mating threaded recess 54 provided in the end 56 of the connecting rod 16. The obstructer 46 can be provided with a hexagonal head to allow operating it with a hexagonal key when securing it with the connecting rod 16, for example.

The second piston head 26 has a body 58 through which both a damping flow path 60 having one or more channels (62, 64) and a central aperture 66 are defined, a compression washer stack 68, and an accessory 70. The accessory 70 has a head 72 with an exposed flat surface 74, and a threaded shaft 76, opposite the flat surface 74 and secured within a threaded portion 78 of the central aperture 66. The accessory 70 has a bypass flow path 80 defined longitudinally therethrough, bearing an opening 82 defined at a center of the flat surface 74, and communicating with the central aperture 66.

Referring both to FIGS. 1 and 2, the compressive response curve of the piston 14 (generated by the first piston head 18) is selected in a manner that the displacement of the piston 14 does not exceed a first portion 84 of the cylinder 12 (FIG. 1) when a predetermined threshold compressive shock is applied to the damper 10. Therefore, the bypass flow path 80 of the second piston head 26 is normally kept open, which maintains the second piston head 26 in a normally inoperative state.

In the event where a compressive shock exceeds the predetermined threshold, the piston 14 is displaced into the second portion 86 of the cylinder 12 (FIG. 1) where the flat obstructing portion 50 of the piston 14 comes into contact with the flat surface 74 around the opening 82 of the bypass flow path 80. This both obstructs the bypass flow path 82 and forces the second piston head 26 to be displaced in the compression orientation 20, thus forcing the damping fluid 30 (FIG. 1) through the damping flow path 60 and the compression washer stack 68 of the second piston head 26. The compression washer stack 68 of the second piston head 26 thus generates a second resistance force to compression (i.e. compression damping force) which is added to the damping force generated by the compression washer stack 42 of the first piston head 18. The total damping force in the second portion 86 of the cylinder 12 is thus the sum of both damping fluid resistances. Typically, the damping force generated by the second piston head 26 is substantially greater than the damping force generated by the first piston head 18, and the total damping force can be approximated to the damping force generated by the second piston head 26 in the second portion 86 of the cylinder 12. The increased damping force in the second portion 86 of the cylinder 12 helps prevent bottoming.

When the movement of the piston 14 comes to a halt, a spring (not shown) applies a restoring force to the damper 10 which restores the piston 14 to its former position. As soon as the orientation of displacement of the piston 14 changes from compression to rebound, damping fluid 30 is allowed through the bypass flow path 80 again, thus allowing the piston 14 to freely return to its former position. The second piston head 26 is then returned to its neutral position by the biasing action of the spring 28.

To help ensure that the obstruction of the bypass flow path 80 during an excessive compressive force is sufficient to force the fluid 30 through the compression washer stack 68 of the second piston head 26, the area of contact between the flat obstructing portion 50 and the flat surface 74 of the accessory 70 should be made sufficiently important relatively to the area of the opening 82 of the bypass flow path 82. In experimentations, using a flat obstructing portion 50 and a flat surface 74 of the accessory 70 having a diameter equivalent to thirteen times the diameter of the opening 82 was found satisfactory. Other values can be used in other applications.

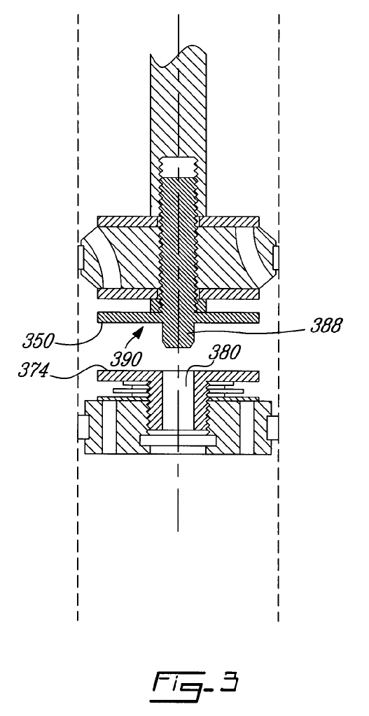

Alternately, as can be seen in FIG. 3, a plug 388 which mates with the bypass flow path 380 can be used in addition to flat surfaces 350, 374 to form an obstructing portion 390 which can achieve an even greater obstruction of the bypass flow path 380 upon an excessive compressive force.

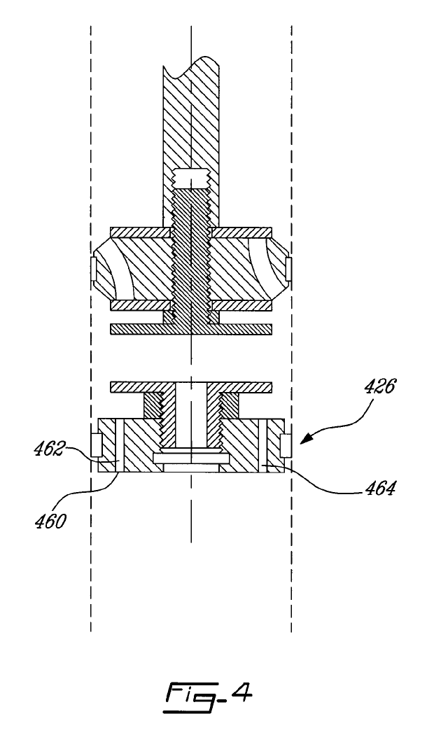

FIG. 4 illustrates an other alternate example to the example illustrated in FIGS. 1 and 2. In this example, the second piston head 426 does not have a washer stack. The compressive response force is determined by the diameter, length, and number of channels 462, 464 (only two are shown) defining the damping flow path 460.

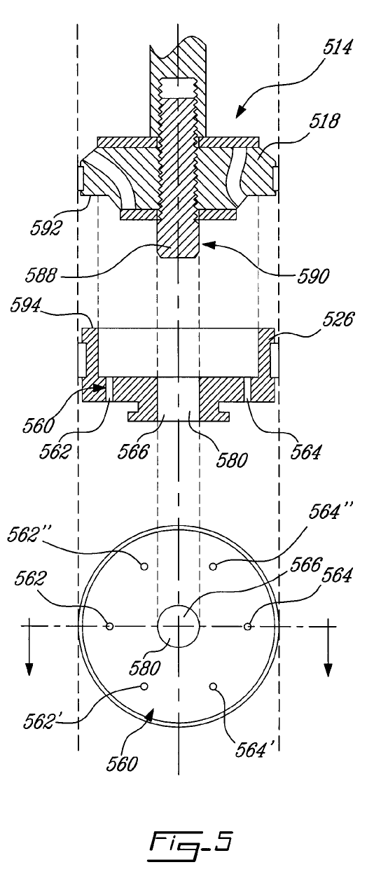

In the alternate example shown in FIG. 5, the obstructing portion 590 has a plug 588 which precisely fits the central aperture 566 to adequately block the bypass flow path 580. The first piston head 518 has an annular pushing portion 592 and the second piston head 526 has a mating annular receiving portion 594. When the piston 514 comes into contact with the second piston head 526, the receiving portion 594 receives the pushing portion 592 of the first piston head 518, and the plug 588 enters the central aperture 566, thus obstructing the bypass flow path 580, and forcing the damping fluid through the damping flow path 560. The lower portion of FIG. 5 schematically depicts a bottom plan view of the components shown in the cross-sectional view. Like in the example of FIG. 4, the compressive response curve is selected here by determining the diameter, length, and number of channels which collectively form the damping flow path. In this case, six channels 562, 562′, 562″, 564, 564′, 564″ form the damping flow path 560.

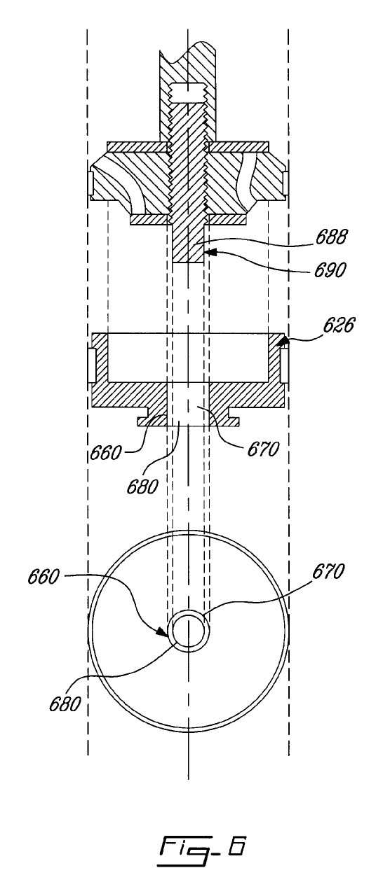

The example shown in FIG. 6 is similar to the example shown in FIG. 5, however, the channels are omitted, and the plug 688 is intentionally made with diameter smaller than the diameter of the central aperture 660 of the second piston head 626. The central aperture 660 of the second piston head 626 both includes the bypass flow path 680 at the center, and the damping flow path 670 around the bypass flow path 680. The compressive response curve is selected by the difference between the diameter of the central aperture 660 and the diameter of the plug 688. Upon an excessive compressive force, the plug 688 acts as the obstructing portion 690 and obstructs the bypass flow path portion 680 of the central aperture 660, thus forcing the damping fluid through the damping flow path portion 670 of the central aperture 660.

It will be noted here that although only second piston heads having a bypass flow path centrally provided therein are discussed above and illustrated, second piston heads having a bypass flow path comprised of one or more independent channels distant from the center can alternately provided, such as with an obstructing portion comprised of a one or more corresponding plugs being provided with the piston, for example.

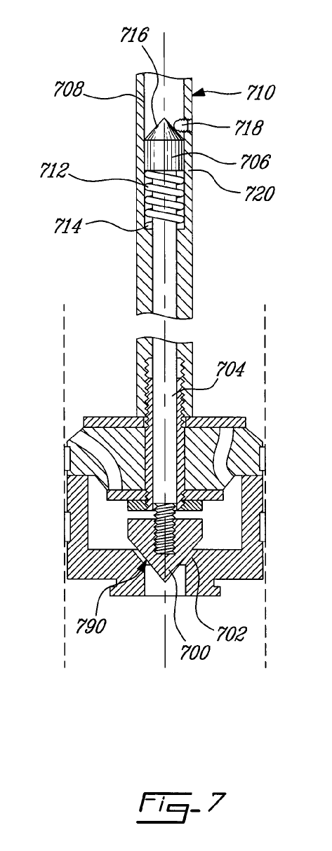

In the example shown in FIG. 7, the compressive response curve in the second portion of the cylinder is made externally adjustable by a user. The obstructing portion 790 has a needle 700 having a conical surface to which a countersink 702 in the central aperture is matingly shaped. The needle 700 is attached to a stem 704 which is slidingly mounted within the connecting rod. The stem 704 has a broad tip 706 opposite the needle 700, which can slide within a corresponding bore 708 defined in the end 710 of the connecting rod which is external to the cylinder. The stem 704 is biased in the rebound orientation by a needle spring 712 mounted in compression between the bottom 714 of the bore 708 and the broad tip 706 of the stem 704. The broad tip 706 has a convex conical surface 716 which abuts against a set screw 718 mounted transversally through the wall 720 of the connecting rod, adjacent to the bore 708. The depth of the needle 700 relative to the contacting portions of the first and second piston heads can thus be adjusted by adjusting the depth of the set screw 718. In use, the needle 700 obstructs the bypass flow path and leaves a damping flow path having the desired width between the countersink 702 and the needle 700 conical surface.

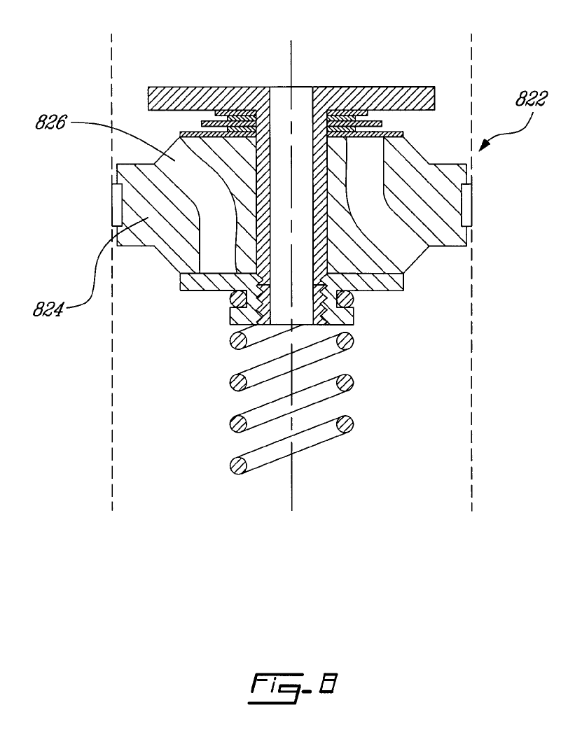

FIG. 8 illustrates an alternate example for a second piston head. This second piston head 822 has a body 824 with two independent flow paths, similar to the body of the first piston head in FIG. 1. However, the rebound flow path 826 is permanently blocked because it is not needed.

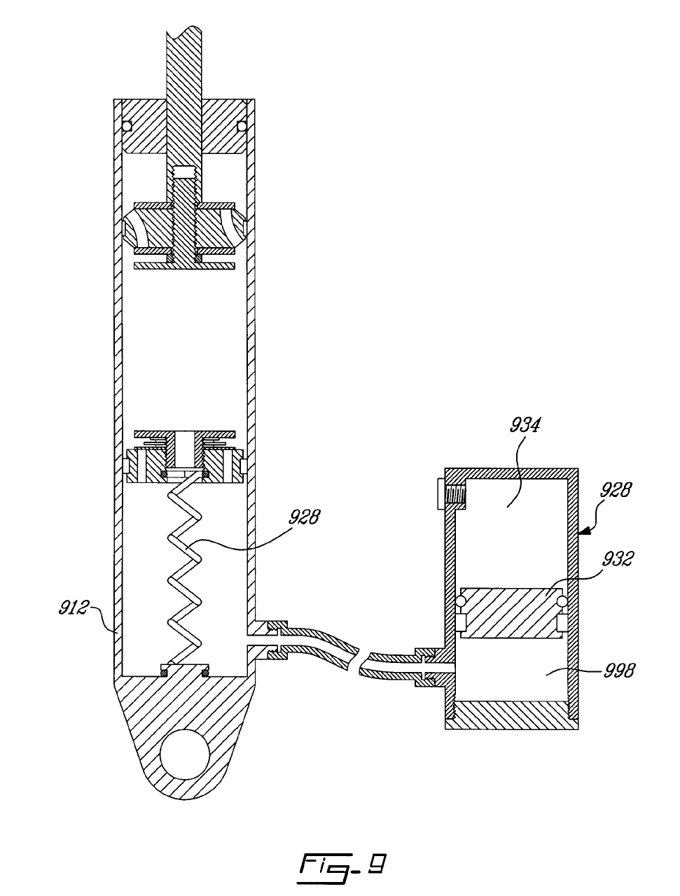

Turning now to FIG. 9, an example where the spring 928 is mounted directly to the bottom of the cylinder 912, instead of being mounted to a floating piston such as in FIG. 1, is shown. In this example, the gas chamber 934 is provided in a secondary cylinder 928 which also has a damping fluid chamber 998 connected to the primary cylinder 912. The damping fluid can be separated from the gas 934 by a floating piston 932, or can alternately be separated from the gas 934 by a bladder (not illustrated), for example.

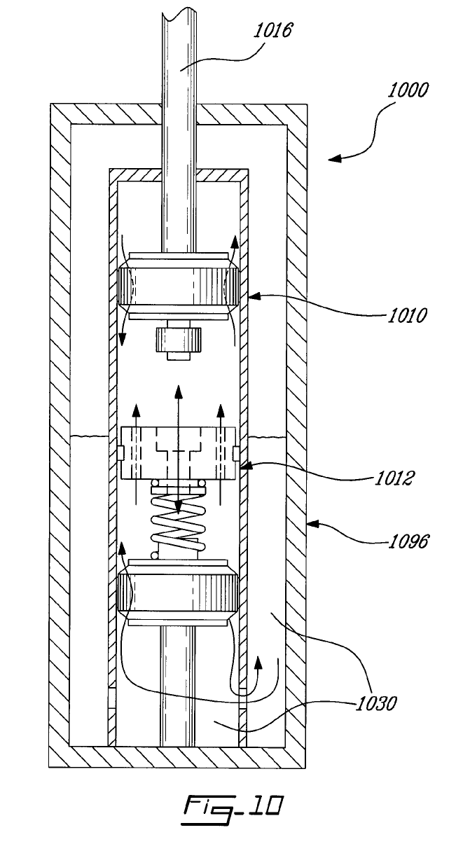

Turning now to FIG. 10, an application of the damper 1010 in a telescoping suspension 1000 such as a motorcycle front fork telescoping suspension is shown. In this application, oil 1030 is transferred between the cylinder 1012 and a housing 1096 disposed around the cylinder 1012 to accommodate the volume of the rod 1016 being displaced in the cylinder 1012.

Further to the alternate examples described above, in other alternate examples, the second piston head can be provided as an annulus around the connecting rod and be for use in the rebound orientation instead or in combination with a second piston head for use in the compression orientation, for example.

As can be seen therefore, the examples described above and illustrated are intended to be exemplary only. The scope is indicated by the appended claims.

What is claimed is:

1. A damper comprising a cylinder with a damping fluid, a piston having a connecting rod slidably carrying a first damping piston head and an obstructing portion in the cylinder, and a second damping piston head slidably mounted in the cylinder independently from the piston and biased to a neutral position, the second damping piston head having a damping flow path and a normally open bypass flow path, the normally open bypass flow path being obstructable by the obstructing portion to force the damping fluid through the damping flow path.

2. The damper of claim 1 wherein the cylinder generally comprises a first portion and a second portion with the neutral position therebetween, and wherein the obstructing portion obstructs the bypass flow path substantially when the obstructing portion moves from the first portion into the second portion of the cylinder.

3. The damper of claim 2 wherein the bypass flow path is freed from the obstructing portion substantially when the movement of the piston passes from the compression orientation to the rebound orientation.

4. The damper of claim 1 further comprising a floating piston slidably mounted in the cylinder and separating the damping fluid from a compressible gas, characterized in that the second damping piston head is connected to the floating piston by a resilient member which biases the second piston head to the equilibrium position.

5. The damper of claim 1 wherein the second piston head has an opening of the bypass flow path surrounded by a generally flat surface, and the obstructing portion has a generally flat surface configured and adapted to mate with the generally flat surface of the second piston head.

6. The damper of claim 1 wherein the obstructing portion has a plug configured and adapted to engage and obstruct the bypass flow path.

7. The damper of claim 1 wherein the bypass flow path includes a single channel.

8. The damper of claim 1 further comprising a washer stack configured and adapted to cause damping when damping fluid is forced through the damping flow path.

9. The damper of claim 1 wherein the damping flow path includes one or more channels which are sized to cause damping when damping fluid is forced through the damping flow path.

10. The damper of claim 1 wherein the size of at least one of the one or more channels is externally adjustable.

11. A method of damping with a damper having a first damping piston head and an obstructing portion collectively normally slid in a first portion of a cylinder having damping fluid and a second piston head having a bypass flow path and a damping flow path, the second piston head being slidable in a second portion of the cylinder, independently of the first piston head, and biased to a neutral position, the method comprising:
sliding the first damping piston head and the obstructing portion into the second portion of the cylinder, thereby obstructing the bypass flow path of the second piston head with the obstructing portion and forcing damping fluid through the damping flow path.

12. The method of claim 11 further comprising, subsequently to said forcing damping fluid through the damping flow path, inverting the sliding orientation of the first damping piston head, thereby releasing the bypass flow path from obstruction by the obstructing portion.

13. A damper comprising a first damping piston head, and a second piston head having a compression damping flow path and a normally open bypass flow path, both the first piston head and the second piston head being slidably mounted in an elongated cylinder having damping fluid therein, the cylinder having a first portion and a second portion along its length, the damper also having a blocking portion configured and adapted for blocking the bypass flow path when the first piston head slides into the second portion of the cylinder, thereby forcing the damping fluid into the compression damping flow path of the second piston head; the damper being CHARACTERIZED IN THAT the second piston head is slidable in the cylinder independently from the first piston head and is slidably biased to an equilibrium position along the cylinder, and in that the blocking portion is associated with the first piston head.

14. The damper of claim 13 wherein the first piston head is mounted to a connecting rod, characterized in that the blocking portion is part of a component which is also mounted to the connecting rod.

15. The damper of claim 13 wherein the damper further comprises a floating piston slidably mounted in the cylinder and separating the damping fluid from a compressible gas, characterized in that the second piston head is connected to the floating piston by a resilient member which biases the second piston head to the equilibrium position.

16. The damper of claim 13 wherein the first piston head has a compression damping flow path and a rebound flow path.

17. The damper of claim 16 wherein the rebound flow path is configured and adapted to provide rebound damping during movement of the first piston head in the rebound orientation.

18. The damper of claim 13 wherein the bypass flow path is substantially freed from the obstructing portion when the movement of the piston passes from a compression orientation to a rebound orientation.

19. The damper of claim 13 wherein the second piston head has an opening of the bypass flow path surrounded by a generally flat surface, and the obstructing portion has a generally flat surface configured and adapted to mate with the generally flat surface of the second piston head.

20. The damper of claim 13 wherein the size of the compression damping flow path is externally adjustable.
